(19) United States
(12) Patent Application Publication
(10) Pub. No.: US 2007/0262948 A1
(43) Pub. Date: Nov. 15, 2007

(54) BACKLIGHT, METHOD FOR DRIVING BACKLIGHT, AND LIQUID CRYSTAL DISPLAY HAVING THE SAME

(76) Inventors: Kwan Young HAN, Suwon (KR); Jae Sik Son, Suwon (KR)

Correspondence Address: MACPHERSON KWOK CHEN & HEID LLP, 2033 GATEWAY PLACE, SUITE 400, SAN JOSE, CA, 95110, US

(21) Appl. No.: 11/744,404

(22) Filed: May 4, 2007

(30) Foreign Application Priority Data
May 11, 2006 (KR) 10-2006-0042620

(51) Int. Cl. G09G 3/36

(52) U.S. Cl. 345/102

(57) ABSTRACT

An LED driving circuit drives LCD backlight LEDs sequentially, reducing LCD display ripple noise without decreasing luminance. The LCD driving circuit includes an LED driving voltage generation unit that generates a driving voltage for a backlight LEDs; a PWM signal control unit that generates PWM output signals having a predetermined duty ratio, shifted at a predetermined time interval; and a switching unit that controls application of the driving voltage to LEDs, responsive to the PWM output signals. A backlight includes LEDs and the LED driving circuit. An LCD having the backlight, and a method for driving the backlight are included.

### BACKGROUND OF THE INVENTION

1. Field of the Invention

The present invention relates to a backlight, a method for driving the backlight, and a liquid crystal display having the same, and more particularly, to a backlight having a light emitting diode (LED) driving circuit for sequentially driving LEDs used as a light source of the backlight, a method for driving the backlight, and a liquid crystal display having the same.

2. Description of the Related Art

In general, a backlight for a liquid crystal display (LCD) may use an electric bulb, a light emitting diode (LED), a fluorescent lamp, a metal halide lamp or a similar light source. Among these, the LED often is used as a backlight light source for a medium- or small-sized LCD, because the LED has a long life span, does not require an additional inverter, has light weight and small thickness, emits light uniformly, and has low power consumption.

Generally, a luminance adjustment of an LED is performed through pulse width modulation (PWM) of a driving voltage. Typically, a high frequency control signal control the driving signal to prevent visually-perceptible LED flickering. However, a typical LCD frame frequency of is about 60 Hz, and a frequency of a LED luminance control signal generally is set higher than the frame frequency, with the difference between the LCD frame frequency and the LED luminance control signals inducing noise that causes ripples in an image displayed on the LCD. Currently, a simplification of a fabricating process permits a thin film transistor substrate to be fabricated through a four-mask process, in which the thin film transistor, an amorphous silicon layer, and a data line are deposited and patterned consecutively, so that the amorphous silicon layer remains beneath the data line and close to a pixel electrode. The amorphous silicon layer is sensitive to light, so that a difference in parasitic capacitance is generated between the pixel electrode and the data line, as an LED is turned ON and OFF. This varying parasitic capacitance affects existing noise in the LED such that visible ripples are seen in a displayed image, and it is desirable to minimize visible image rippling.

### SUMMARY

A light emitting diode (LED) driving circuit, for improving a noise causing ripples in an image displayed on a liquid crystal display (LCD), a method for driving the backlight, and a liquid crystal display having the same. According to an aspect of the present invention for achieving the object, there is provided a backlight, comprising a plurality of light emitting diodes (LEDs), and an LED driving circuit for driving the plurality of LEDs, wherein the LED driving circuit includes an LED driving voltage generation unit for generating a driving voltage for driving the plurality of LEDs, a pulse width modulation (PWM) signal control unit for generating a plurality of PWM signals that have a predetermined duty ratio and are shifted at a predetermined time interval so as to sequentially drive the plurality of LEDs, and a switching unit for performing control such that the driving voltage can be applied to each of the LEDs in response to the plurality of PWM signals. The PWM signal control unit may have a shift circuit unit for shifting an arbitrary PWM signal having a predetermined duty ratio at a predetermined time interval so as to output a plurality of PWM signals. The duty ratio of each of the PWM signals may be between about 1% to about 99%. The frequency of each of the PWM signals may be at least about 160 Hz.

The LED driving voltage generation unit may have a pumping circuit for outputting a voltage with a certain amplitude regardless of the amplitude of an input voltage. The plurality of LEDs may comprise at least two LED groups and are sequentially driven on an LED group basis. Each of the LED groups may include at least one LED. The plurality of LEDs may be arranged in a line while being spaced apart from one another, and each of the LED groups may include adjacent LEDs. The plurality of LEDs may be arranged in a line while being spaced apart from one another, and each of the LED groups may include LEDs arranged to space apart from one another. Any one electrode of each of the LEDs may be connected to an output terminal of the LED driving voltage generation unit; the other electrode of each of the LEDs may be connected to the switching unit; and an output terminal of the PWM signal control unit may be connected to the switching unit.

The switching unit may comprise a plurality of switching elements respectively corresponding to the LED groups, and each of the switching elements may perform a switching operation in response to each of the PWM signals. The switching element may comprise a transistor. The plurality of LEDs may be connected in parallel to one another; an anode of each of the LED groups may be connected to an output terminal of the LED driving voltage generation unit; a cathode of each of the LED groups may be connected to a drain terminal of each of the transistors; a gate terminal of each of the transistors may be connected to an output terminal of the PWM signal control unit; and a source terminal of each of the transistors may be connected to a ground.

According to another aspect of the present invention, there is provided a liquid crystal display (LCD), comprising a backlight including a plurality of light emitting diodes (LEDs), and an LED driving circuit for driving the plurality of LEDs, wherein the LED driving circuit includes an LED driving voltage generation unit for generating a driving voltage for driving the plurality of LEDs, a pulse width modulation (PWM) signal control unit for generating a plurality of PWM signals that have a predetermined duty ratio and are shifted at a predetermined time interval so as to sequentially drive the plurality of LEDs, and a switching unit for performing control such that the driving voltage can be applied to each of the LEDs in response to the plurality of PWM signals; and an LCD panel including a thin film transistor (TFT) substrate, a color filter substrate facing the TFT substrate, and an liquid crystal layer injected between the TFT substrate and color filter substrate.

The PWM signal control unit may have a shift circuit unit for shifting an arbitrary PWM signal having a predetermined duty ratio at a predetermined time interval so as to output a plurality of PWM signals. The plurality of LEDs may comprise at least two LED groups and are sequentially driven on an LED group basis. Each of the LED groups may include at least one LED. The duty ratio of each of the PWM signals may be between about 1% to about 99%. The frequency of each of the PWM signals may be at least about 160 Hz.

The TFT substrate may be formed using 4 masks. The TFT substrate may comprise gate lines formed to extend in one direction on a substrate; data lines formed to intersect the gate lines while being insulated from the gate lines; TFTs which are formed at intersection regions of the gate and data lines and connected to the gate and data lines and each of which has gate and source-drain electrodes; and pixel electrodes connected to the TFTs. Each of the data lines may include an active layer, an ohmic contact layer and source-drain electrodes is consecutively deposited and simultaneously patterned.

According to a further aspect of the present invention, there is provided a method for driving a backlight having a plurality of LEDs, comprising the steps of generating a driving voltage for driving the plurality of LEDs; generating a plurality of pulse width modulation (PWM) signals having a predetermined duty ratio and being shifted at a predetermined time interval so as to sequentially drive the plurality of LEDs at the predetermined time interval; and applying the driving voltage to each of the LEDs in response to the plurality of PWM signals.

### BRIEF DESCRIPTION OF THE DRAWINGS

FIG. 1A is a schematic illustration of a conventional light emitting diode (LED) driving circuit configuration, and FIG. B is a diagram of a driving voltage waveform generated by the LED driving circuit of FIG. 1A, as applied to an LED;

FIG. 2 is an exploded perspective view of a liquid crystal display (LCD) having a backlight according to an embodiment of the present invention;

FIG. 3A is a schematic plan view of a thin film transistor (TFT) substrate according to an embodiment of the present invention;

FIGS. 3B through 3E are sectional views illustrating a process of fabricating the TFT substrate according to an embodiment of the present invention;

FIGS. 4A and 4B are sectional views illustrating the principle of differential parasitic capacitance generation in accordance with on/off power toggling of a backlight;

FIG. 5 is a schematic illustration of an LED driving circuit of a backlight according to an embodiment of the present invention;

FIGS. 6 and 7 is a diagram representing pulse width modulation (PWM) output signal waveforms from a PWM control unit;

FIG. 8 is a schematic illustration of a backlight LED driving circuit configuration, according to another embodiment of the present invention;

FIGS. 9A to 9C are block depictions illustrating arrangement embodiments of LED groups in a backlight, according to the present invention;

FIG. 10 is a graph comparing luminance variations in LCDs according to the present invention with luminance variations according to the prior art; and

FIG. 11 is a table comparing luminance values by duty ratios of PWM output signals in LCDs according to the present invention and to the prior art.

### DETAILED DESCRIPTION OF THE INVENTION

In the drawings, the thicknesses of layers and regions are exaggerated for clarity, and like reference numerals are used to designate like elements throughout the specification and drawings. Further, an expression that an element such as a layer, region, substrate or plate is placed on or above another element indicates not only a case where the element is placed directly on or just above the other element but also a case where a further element is interposed between the element and the other element.

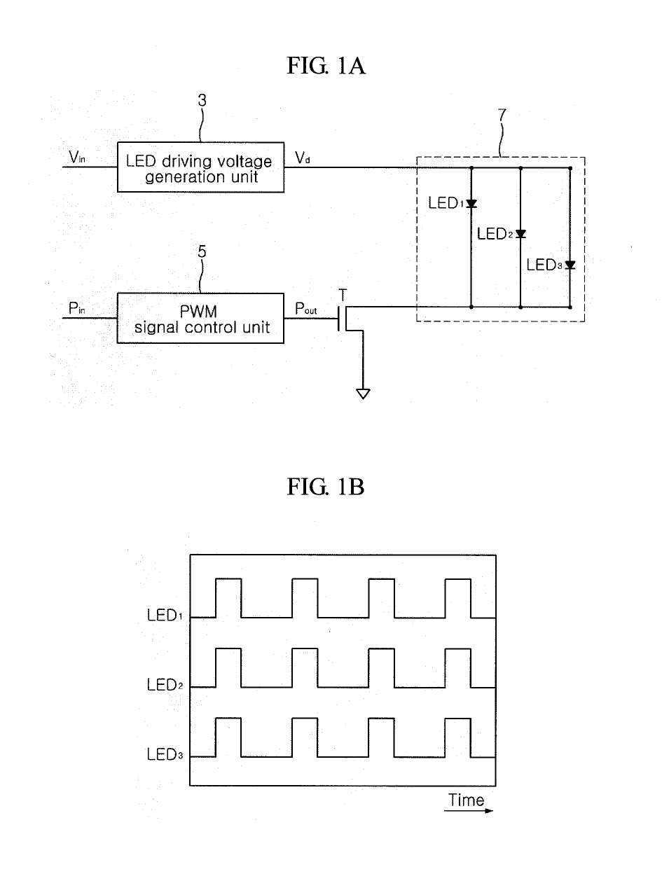

FIGS. 1A and 1B illustrate the operating principles of a conventional LED driving circuit. The conventional LED driving circuit in FIG. 1A includes an LED driving voltage generation unit 3, a PWM signal control unit 5, and a switching element T. A driving voltage V_{d} is output from the LED driving voltage generation unit 3, and is applied to a plurality of LEDs 7 simultaneously. FIG. 1B illustrates conventional driving voltage waveforms of LED1, LED2, and LED3, driven simultaneously. In general, V_{d} is applied in response to a control signal output from the PWM signal control unit 5, so that the plurality of LEDs 7 can be turned on or off simultaneously.

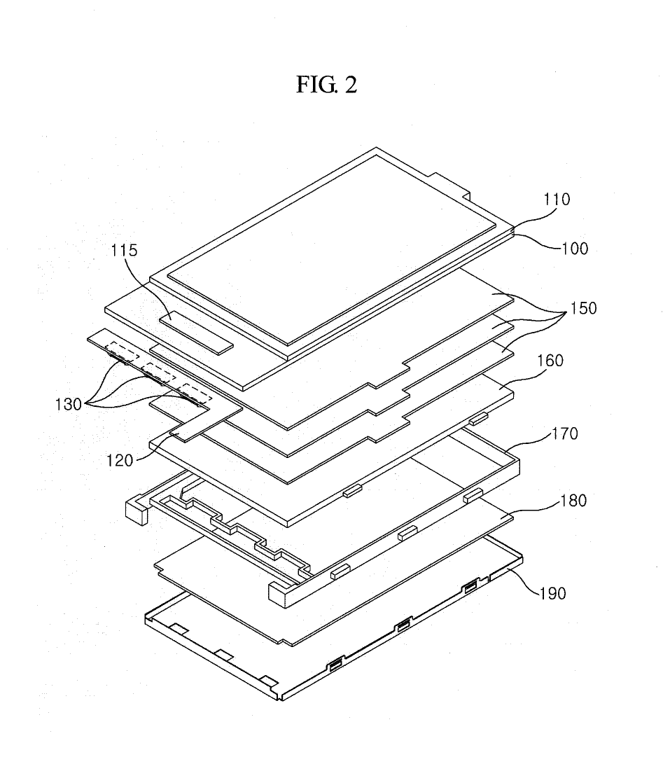

FIG. 2 is an exploded perspective view of a liquid crystal display (LCD) assembly having a backlight according to the present invention. Referring to FIG. 2, the LCD assembly comprises an LCD panel having a thin film transistor (TFT) substrate 100 and a color filter substrate 110 bonded together therein; an LCD drive IC 115; a main flexible printed circuit board (not shown); an LED flexible printed circuit board 120; a plurality of LEDs 130; a plurality of optical sheets 150; a light guide plate 160; a mold frame 170; a reflection plate 180; and a bottom chassis 190.

The color filter substrate 110 of the LCD panel is a substrate in which red, green, and blue (RGB) pixels are formed by a thin-film process. The RGB pixels serve as color pixels for expressing predetermined colors upon passage of light therethrough. A transparent conductor, such as indium tin oxide (ITO) or indium zinc oxide (IZO), is applied to an entire surface of the color filter substrate 110 to form a common electrode. The TFT substrate 100 is a transparent glass substrate, on which TFTs are arrayed in a matrix form. Liquid crystals are injected into a space between the TFT substrate 100 and the color filter substrate 110. Each TFT has a source terminal, a gate terminal, and a drain terminal. As is well known in the art, data lines are connected to source terminals of the TFTs, while gate lines are connected to gate terminals thereof. Further, pixel electrodes, comprising transparent electrodes made of a transparent conductive material, are formed at drain terminals. The respective TFTs can be turned on or off by applying electric signals to the data and gate lines, with the electrical signals used to form pixels being applied to the drain terminals. If electric power is applied to the gate and source terminals of the TFT substrate 100 to turn on TFTs, an electric field is created between the common electrode of the color filter substrate 110 and the pixel electrodes. The electric field changes an alignment of liquid crystals, which accordingly changes LCD light transmittance, thereby producing desired images. The LCD driving IC 115 is mounted on the TFT substrate 100, using a chip on glass (COG) method to operate the LCD panel. The LCD driving IC 115 comprises a gate driving unit and a data driving unit. The gate and data driving units apply predetermined gate and data signals to the gate and data lines of the TFT substrate 100, respectively.

The main flexible printed circuit board (not shown) is mounted at one end of the TFT substrate 100 to be electrically and mechanically connected to the LCD panel and the LCD driving IC 115. A variety of circuit components for operating the LCD panel, e.g., an LED driving circuit to be described below and the like, are mounted on the main flexible printed circuit board. The LEDs 130 are mounted on the LED flexible printed circuit board 120 and driven by the LED driving circuit mounted on the main flexible printed circuit board.

In this embodiment, three LEDs are mounted in a line on the LED flexible printed circuit board 120, while being spaced apart from one another at a predetermined interval. The LED driving circuit is configured to drive the LEDs 130 sequentially. With respect to the LED driving circuit, the light guide plate 160 may be placed on one side of the LEDs 130. Plate 160 converts light emitted from the LEDs 130 into light having approximately the same optical distribution as light from a surface light source. A reflection plate 180 is positioned beneath the light guide plate 160, and is installed to come into contact with a bottom surface of the bottom chassis 190. Desirably, reflection plate 180 exhibits high reflectivity. To ensure uniform luminance distribution of light emitted from the light guide plate 160, the optical sheets 150 and a diffusion plate are positioned on the light guide plate 160. The optical sheets 150 includes a plurality of prism sheets. The mold frame 170 has a storage space formed therein, and the aforementioned components are accommodated in the storage space. The bottom chassis 190 is coupled to the mold frame 170.

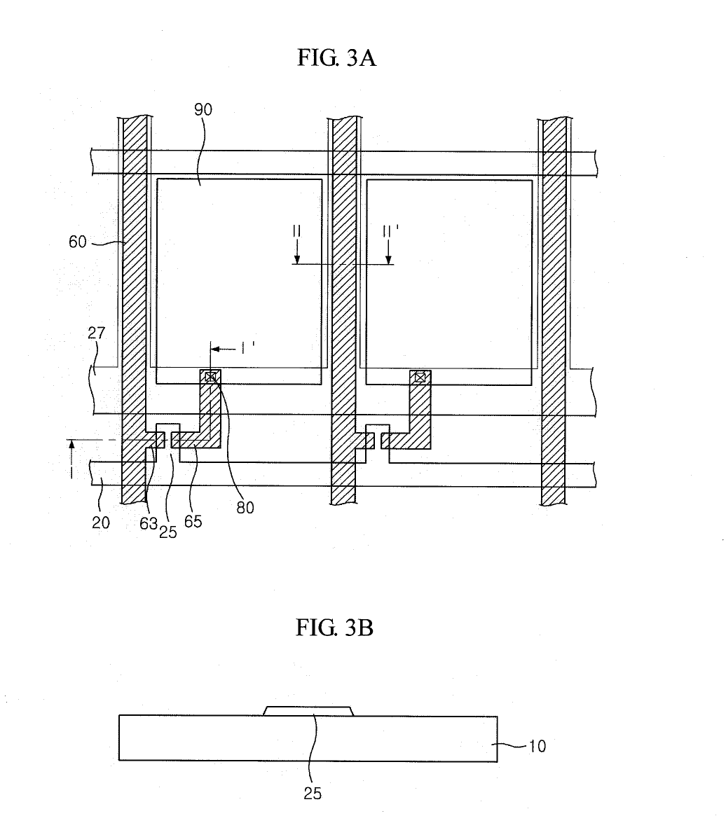

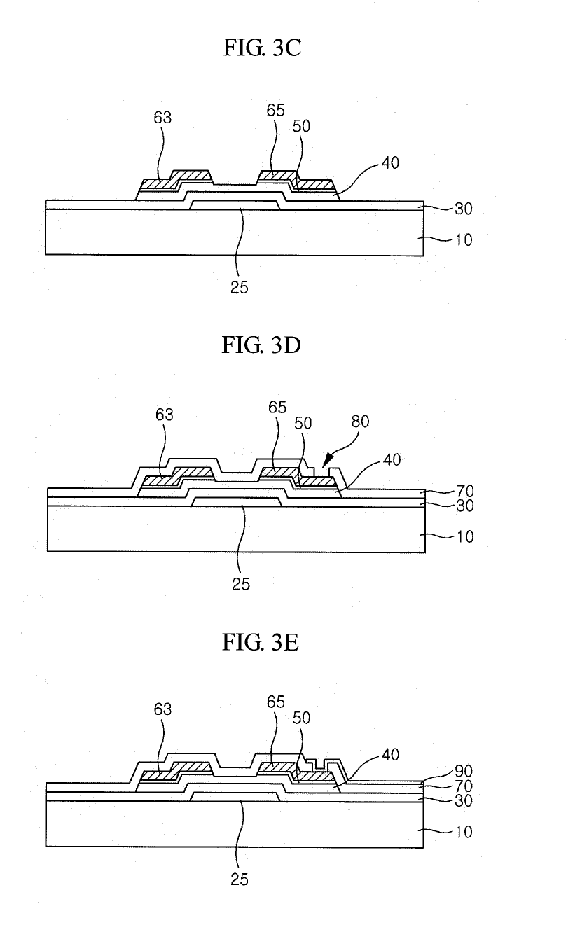

FIG. 3A is a schematic plan view of a thin film transistor (TFT) substrate according to the present invention. FIGS. 3B to 3E are sectional views of the TFT substrate taken along line I-I′ in FIG. 3A and show the sections of the TFT substrate in the respective mask processes. FIG. 3B illustrates a TFT substrate in the first mask process; FIG. 3C illustrates a TFT substrate in the second mask process; FIG. 3D illustrates a TFT substrate in the third mask process; and FIG. 3E illustrates a TFT substrate in the fourth mask process.

FIG. 3A depicts a TFT substrate that comprises gate lines 20 disposed in a first direction, and data lines 60 disposed to intersect, but being insulated, from the gate lines 20. The TFT comprises a gate electrode 25, formed to extend from the gate line 20; a source electrode 63, formed to extend from the data line 60; and a drain electrode 65, connected to the pixel electrode 90. Unit pixels are formed at intersection regions of the gate lines 20, data lines 60, and storage capacitor electrode lines 27. A unit pixel comprises a TFT, a pixel electrode 90, and a storage capacitor electrode.

Turning to FIG. 3B, a conductive film is first laminated on a substrate 10 by means of a method such as sputtering. Using a first mask, a photo-etching process is used to form a storage capacitor electrode line (not shown) and gate line patterns including a gate electrode 25. The conductive film may be wet- or dry-etched. In FIG. 3C, a gate insulation film 30 is formed on substantially an entire surface of the substrate 10 using, for example, a chemical vapor deposition (CVD) or sputtering method. The gate insulation film 30 can be an inorganic insulator including, without limitation, SiOx or SiNx. Using a CVD or sputtering method, an active layer 40, an ohmic contact layer 50, and metal layers including source metal layer 63, and drain metal layer 65, are deposited sequentially to a predetermined thickness on the gate insulation film 30. The active layer 40 is an amorphous silicon layer, and the ohmic contact layer 50 is doped with highly concentrated N-type impurities. After the respective deposited layers have been formed, a data line pattern including an active region and source/drain metal layers is formed using a second mask. Then, a photoresist pattern is formed to include a defined step portion. The defined step portion is desirable because a region in which a channel portion of a TFT will be formed, has a smaller height than the height of other formed regions. The source/drain metal layers and the amorphous silicon layer are consecutively etched using this photoresist pattern having a defined step portion.

Further, after the defined step portion of the photoresist pattern is etched back, only a portion of the photoresist pattern remains in the channel region that is capable of removing the source metal layer 63 and the drain metal layer 65. Subsequently, after the source metal layers 63 and drain metal layer 65 are etched in the channel region, the photoresist pattern is removed. To complete the structure shown in FIG. 3C, the ohmic contact layer 50 is etched back using the source metal layer 63 and the drain metal layer 65 as a mask, leaving the active layer 40 and the ohmic contact layer 50 to remain along and beneath the data line 60. FIG. 3D illustrates a third mask process in which an insulation protection film 70 is deposited on the entire surface of the substrate, and a contact hole 80 is formed, to later be connected to a pixel electrode, e.g., pixel electrode 90. By way of the fourth mask process illustrated in FIG. 3E, a pixel electrode 90 is formed, after a transparent conductive film is deposited on substantially the entire surface of the substrate. An exemplary material for the formed transparent conductive film includes ITO or IZO.

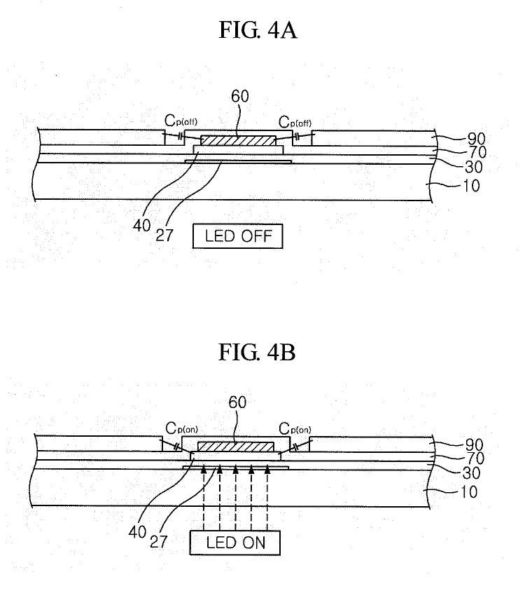

FIGS. 4A and 4B are sectional views of the TFT substrate taken along line II -II′ in FIG. 3A, which illustrate a principle by which a difference in parasitic capacitance is generated in response to the driven state of a corresponding LED, i.e., whether the LED is ON or OFF. Referring to FIGS. 4A and 4B, using the aforementioned four-mask process to form a TFT structure, the amorphous silicon layer 40 is positioned beneath the data line 60. A parasitic capacitance Cp is produced between the data line 60 and the pixel electrode 90. In general, when an amorphous silicon layer 40 receives light emitted from an LED, it functions as a conductor. Impingement of light onto amorphous silicon layer 40 changed the parasitic capacitance Cp between data line 60 and the pixel electrode 90.

In FIG. 4A, the LED is not driven (OFF) and amorphous silicon layer 40 does not conduct. In this case, the parasitic capacitance Cp(OFF) represents the value of capacitance formed between the pixel electrode 90 and a conductive upper layer of the data line 60. In contrast, as illustrated in FIG. 4B, the amorphous silicon layer 40 conducts when the LED is driven (ON). As a result, the parasitic capacitance Cp(ON) shifts to become the value of capacitance formed between the pixel electrode 90 and the amorphous silicon layer 40. Because the pixel electrode 90 is located closer to the amorphous silicon layer 40, the value of parasitic capacitance Cp typically increases when the LED is on. Thus, FIG. 4A and FIG. 4B illustrate that the parasitic capacitance between the data line 60 and the pixel electrode 90 varies in accordance with the driven state (ON/OFF) of the LED. Therefore, In general, ΔCp=Cp(ON)−Cp(OFF), where ΔCp>0.

Variations in parasitic capacitance Cp also changes the amount of charge in the liquid crystals, further aggravating the ripple noise produced by the difference between the LCD frame frequency and the PWM output signal used to control the LED driving voltage. Embodiments of the present invention also include a backlight driving circuit for sequentially driving a plurality of LEDs, at a predetermined time interval, to decrease parasitic capacitance variations caused by the LED driven state (ON/OFF), so that ripples are not visible in the displayed image.

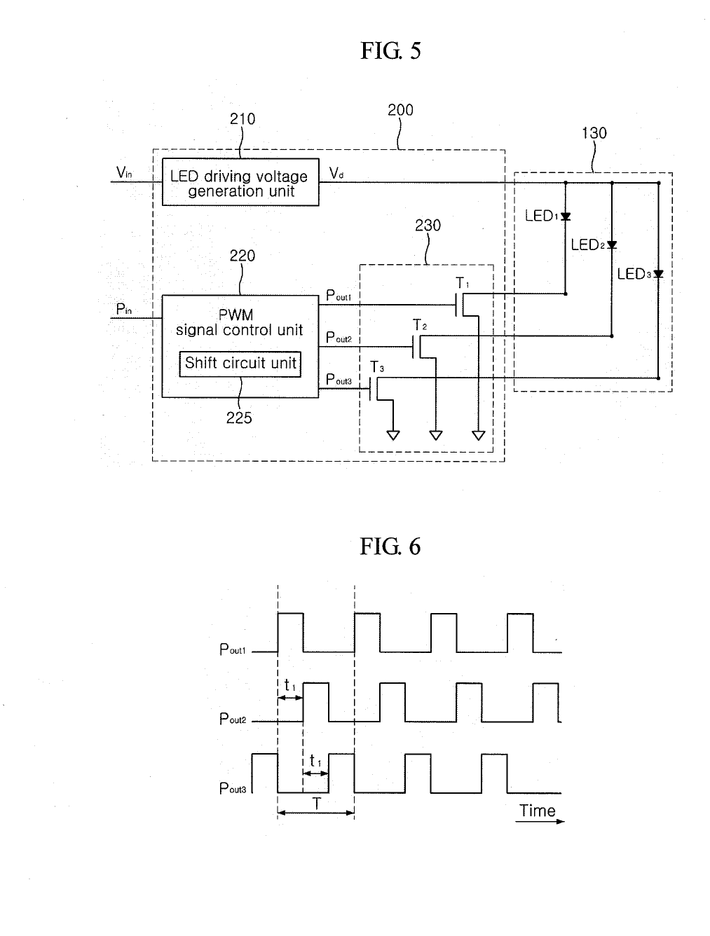

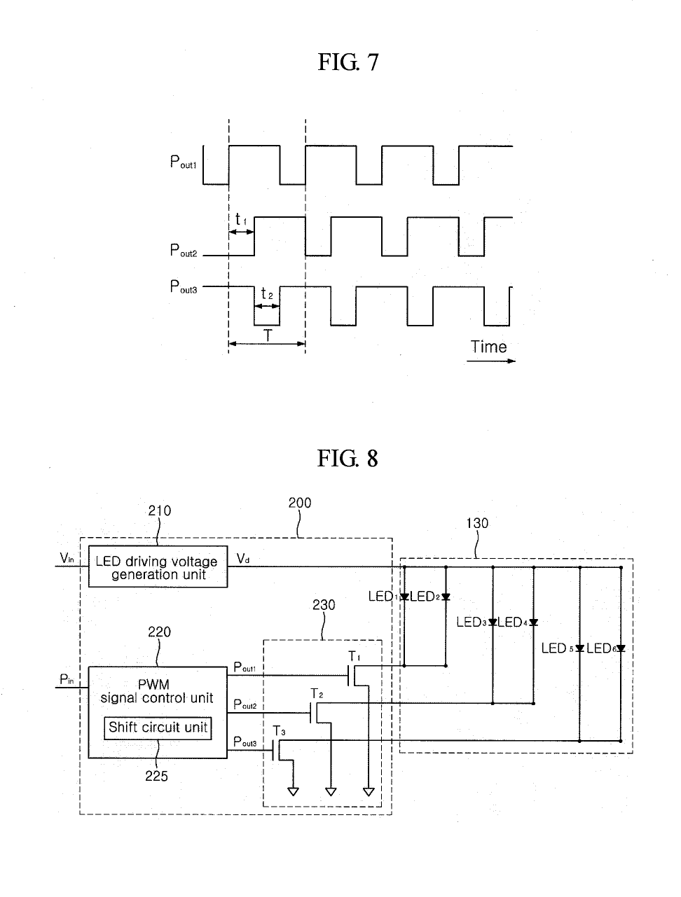

FIG. 5 schematically illustrates the configuration of a backlight LED driving circuit according to an embodiment of the present invention. Also, FIGS. 6 and 7 depict pulse width modulation (PWM) signals output waveforms from a PWM control unit. Referring to FIG. 5, the backlight according to an embodiment of the present invention comprises a plurality of LEDs 130, and an LED driving circuit 200 configured to drive the plurality of LEDs 130 sequentially. The LED driving circuit 200 comprises an LED driving voltage generation unit 210, a PWM signal control unit 220, and a switching unit 230. The LED driving voltage generation unit 210 generates a driving voltage Vd for driving the plurality of LEDs 130. Because an external input voltage Vin to the LED driving voltage generation unit 210 may not be uniform, it is desirable to include in the LED driving voltage generation unit, a pumping circuit for outputting as a constant DC voltage with a preselected amplitude.

To sequentially drive the plurality of LEDs, the PWM signal control unit 220 generates a plurality of PWM output signals having a preselected duty ratio and shifted at a predetermined time interval. The PWM signal control unit 220 includes a shift circuit unit 225, which receives a PWM input signal Pin, shifts the input signal Pin at the predetermined time interval, and outputs the shifted signal. Accordingly, PWM signal control unit produces three PWM output signals Pout1, Pout2, and Pout3, which respectively and individually control a driving voltage applied to each of LED1, LED2, and LED3 of the plurality of LEDs 130, which are connected in parallel. The switching unit 230 comprises three switching elements, for example, transistors T1, T2, and T3, that respectively connect PWM output signals Pout1, Pout2, and Pout3 to LED1, LED2, LED3 of the plurality of LEDs 130.

Each output terminal of the LED driving voltage generation unit 210 is connected to a respective anode of each of LED1, LED2, LED3 of the plurality of LEDs 130. a respectiveA cathode of each of the LEDs 130 is connected to a drain terminal of a respective one of the transistors T1, T2, and T3. The gate terminal of each of the transistors T1, T2, and T3 is connected to a respective one of the output terminals of the PWM signal control unit 220. A source terminal of each of the transistors T1, T2, and T3 is connected to a ground. Switching unit 230 controls the driving voltage Vd applied by LED driving voltage generation unit 210 to each of LED1, LED2, and LED3 of the plurality of LEDs 130, in accordance with each of the PWM signals Pout1, Pout2, and Pout3, respectively. As a result, a driving voltage applied to each of the LEDs 130 (LED1, LED2, and LED3) corresponds to an output waveform of each of the PWM signals Pout1, Pout2, and Pout3.

Desirably, the duty ratios of the PWM output signals produced by PWM signal control unit 220 are substantially identical and are generally in a range of between about 1% to about 99%. However, it also may be desirable to generate PWM output signals with different duty ratios.

FIG. 6 illustrates PWM output signals produced by PWM signal control unit 220, having a duty ratio (t/T) of about 33%. If each of the PWM output signals has a duty ratio of about 33%, each of LEDs 130 is ON for a duration of t₁ and the PWM output signals do not overlap over one period T. As a result, the driving voltages applied to the respective LEDs also do not overlap. For example, when the first LED, LED1 is ON, the second LED, LED2 and the third LED, LED3, are OFF. When second LED, LED2 is ON, first LED, LED 1 is OFF. Similarly, when the third LED, LED3, is ON, first LED, LED1, and second LED, LED2 are OFF.

In contrast, as illustrated in FIG. 7, if each of the PWM output signals (Pout1, Pout2, Pout3) has a duty ratio (t/T) of about 67%, an interval during which one of the PWM output signals (Pout1, Pout2, Pout3) overlaps with another within one period T. As a result, the driving voltages applied to the respective LEDs also overlap, so that two LEDs of the three LEDs are simultaneously ON for a predetermined period of time. When a plurality of LEDs within an LCD are sequentially driven in this manner, the influence of light-induced changes in electrical properties the amorphous silicon layer is reduced which, in turn, reduces parasitic capacitance variations corresponding to the driven state of an LED (ON/OFF). By reducing parasitic capacitance variation, ripple noise can be reduced, as well. Beneficially, the intervals of overlap during which a plurality of LEDs are turned ON generally increase brightness, and producing an LCD having high luminance. Although an LED driving circuit, having three LEDs and three transistors, has been described, this configuration was provided solely for illustration, and the number of LEDs and transistors are not limited thereto.

FIG. 8 schematically depicts a backlight LED driving circuit according to another embodiment of the present invention, configured to drive groups of LEDs sequentially, which is illustrated by an LED driving circuit for sequentially driving three LED groups. Exemplary first LED group comprises first LED, LED1, and second LED, LED2; exemplary second LED group comprises third LED, LED3, and fourth LED, LED4; and exemplary third LED group comprises fifth LED, LED5, and sixth LED LED6. Desirably, the LEDs within each of LED groups are connected in parallel.

An anode of each of the LEDs (LED1-LED6) is connected to the output of the LED driving voltage generation unit 210. The cathodes of each LED group is connected to a transistor. As illustrated, cathodes of LED1 and LED2 are connected to the of first transistor T1; cathodes of LED3 and LED4 are connected to the drain of second transistor T2; and cathodes of LED5 and LED6 are connected to the drain terminal of third transistor T3. In addition, a gate terminal of each of the transistors T1, T2, and T3 is connected to a respective output terminal of the PWM signal control unit 220. The source terminal of each of the transistors T1, T2 and T3 is connected to a ground.

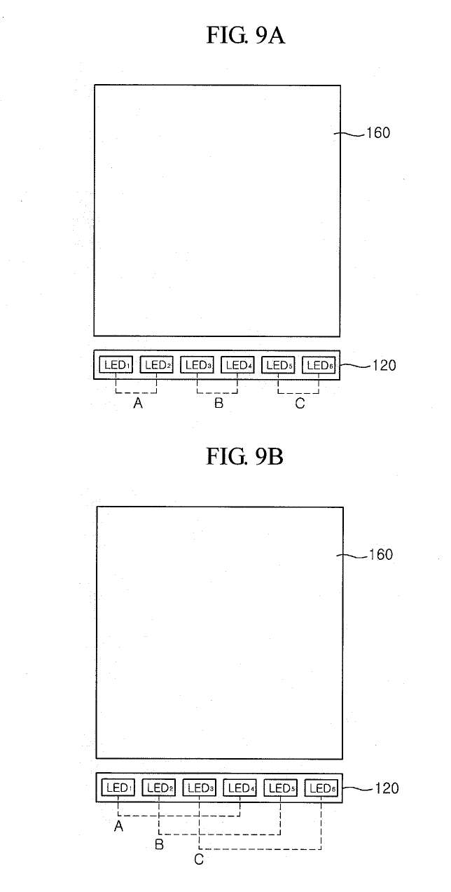

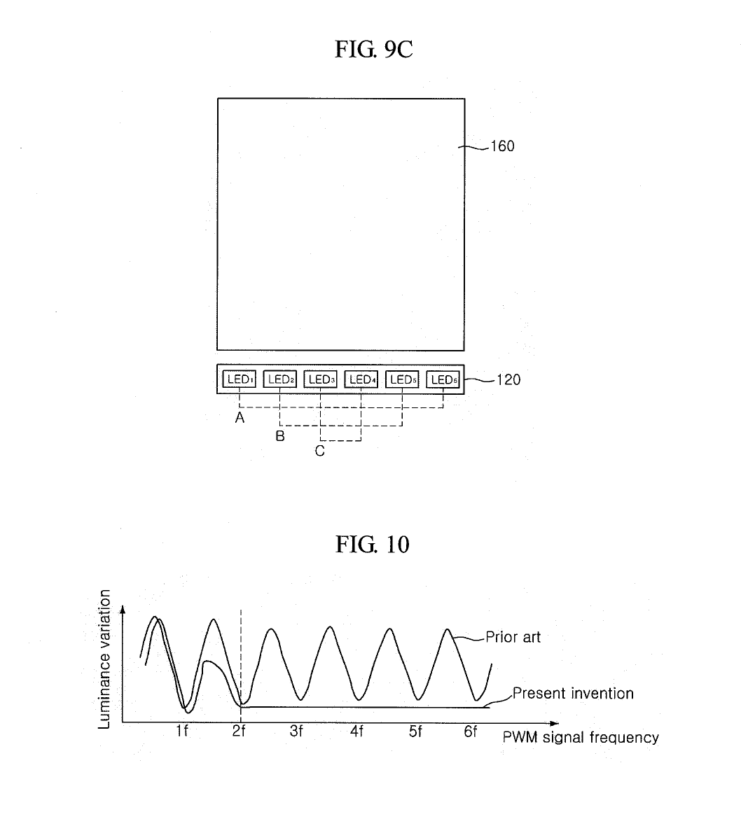

FIGS. 9A to 9C illustrate exemplary arrangements of LED groups in a backlight according to an embodiment of the present invention, in which six LEDs are divided into three LED groups, are mounted on the LED flexible printed circuit board 120, and generally are spaced apart at a predetermined interval. FIG. 9A shows a first exemplary arrangement, in which adjacent LEDs constitute an LED group. First LED group A comprises adjacent LED1 and LED2; second LED group B comprises adjacent LED3 and LED4; and third LED group C comprises adjacent LED5 and LED6. FIG. 9B shows a second exemplary arrangement, in which non-adjacent LEDs constitute an LED groups, where the LEDs of each LED group are spaced apart at a predetermined interval. A first LED group A comprises LED1 and LED4; a second LED group B comprises LED2 and LED5; and a third LED group C comprises LED3 and LED6. FIG. 9C shows a third exemplary arrangement, in which a first LED group A comprises LED1 and LED6; a second LED group B comprises LED2 and LED5; and a third LED group C comprises LED3 and LED4. Also, within the scope of the present invention are modifications to the number of LEDs constituting an LED group, and to the number, predetermined interval, and arrangement of LED groups provided in a backlight.

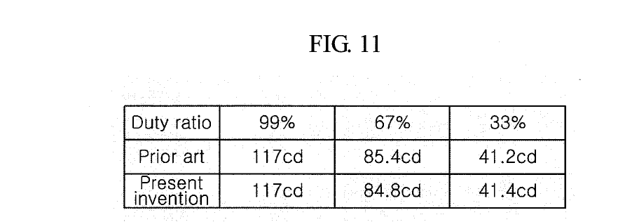

FIG. 10 is a graph of LCD luminance variations comparing embodiments of the present invention to the prior art, and FIG. 11 is a table of LCD luminance values produced by duty ratios of PWM signals in LCDs according to embodiments of the present invention compared to prior art. In FIG. 10, luminance variations, i.e., ripples, are visible in an image displayed on the prior art LCD. By comparison, luminance variations in an image are hardly visible on an LCD having a backlight in which LEDs are driven sequentially, and in which PWM output signal frequency is at least about twice the frame frequency. Accordingly, in a present backlight driving circuit embodiment, it is desirable to use a PWM signal frequency that is at least about twice the LCD frame frequency, and can be at least about 160 Hz. FIG. 11 is a table in which a luminance value produced by LED driven sequentially, in accordance with present embodiments, is compared with a luminance value produced by LED driven in the manner of the prior art. Luminance values are compared at three duty ratios, namely 99%, 67%, and 33%. While the graph of FIG. 10 shows reduction in ripple noise using sequentially-driven LEDs according to the present invention, the table of FIG. 11 demonstrates little or no reduction in LCD luminance produced by LEDs driven in accordance with the embodiments herein, as compared with LEDs driven in accordance with the prior art.

Although the exemplary structure described herein illustrates a light emitting device that is positioned at a side of a light guide plate, the scope of the invention herein is not limited thereto, and it will be apparent that the present invention may be applied as well to a structure in which a plurality of light emitting devices are mounted, for example, as in a direct-type backlight.

The foregoing is merely an exemplary embodiment of a backlight, a method and circuit for driving the backlight, and a liquid crystal display having the same according to the present invention, and thus, the present invention is not limited thereto. It will be readily understood by those skilled in the art that various modifications and changes can be made thereto without departing from the technical spirit and scope of the present invention defined by the appended claims, and that the modifications and changes fall within the scope of the present invention.

What is claimed is:

1. A backlight, comprising:
a plurality of light emitting diodes (LEDs), each LED having two electrodes, including an anode and a cathode; and
an LED driving circuit configured to drive the plurality of LEDs,
wherein the LED driving circuit includes:
an LED driving voltage generation unit having an output and configured to generate a driving voltage for driving the plurality of LEDs;
a pulse width modulation (PWM) signal control unit having an input, and configured to generate a plurality of PWM output signals on the outputs having a predetermined duty ratio and shifted at a predetermined time interval, wherein the plurality of PWM output signals drive the plurality of LEDs sequentially; and
a switching unit configured to control the driving voltage applied to each of the LEDs, in response to the plurality of PWM signals.

2. The backlight of claim 1, wherein the PWM signal control unit comprises a shift circuit unit configured to shift a PWM input signal at a predetermined time interval and to output a plurality of PWM signals, wherein the PWM input signal has a predetermined duty ratio.

3. The backlight of claim 1, wherein the LED driving voltage generation unit comprises a pumping circuit for outputting a voltage having a preselected amplitude substantially independent of an input voltage amplitude.

4. The backlight as of claim 1, wherein the plurality of LEDs comprise at least two LED groups and wherein the plurality of LEDs are driven sequentially on an LED group basis, and each of the at least two LED groups includes an anode and an electrode.

5. The backlight of claim 4, wherein each of the at least two LED groups comprises at least one LED.

6. The backlight of claim 5, wherein the plurality of LEDs are arranged in a line and spaced apart, and wherein each of the at least two LED groups comprises adjacent LEDs.

7. The backlight of claim 5, wherein the plurality of LEDs are arranged in a line and spaced apart, and wherein each of the at least two LED groups includes LEDs arranged spaced apart at a predetermined interval.

8. The backlight of claim 5, wherein one electrode of each of the plurality of LEDs is connected to a LED driving voltage generation unit output, wherein the other electrode of each of the plurality of LEDs is connected to the switching unit; and wherein a PWM signal control unit output is connected to the switching unit.

9. The backlight of claim 8, wherein the switching unit comprises a plurality of switching elements, wherein each of the plurality of switching elements corresponds to a respective one of the at least two LED groups, and wherein each of the plurality of switching elements is configured to perform a switching operation, in response to a respective one of the plurality of PWM output signals.

10. The backlight of claim 9, wherein the switching element comprises a transistor having a source terminal, a gate terminal, and a drain terminal.

11. The backlight of claim 10, wherein ones of the plurality of LEDs are connected in parallel to others of the plurality of LEDs; wherein an anode of each of the at least two LED groups is connected to an LED driving voltage generation unit output; wherein a cathode of each of the LED groups is connected to a drain terminal of each of the plurality of transistors; wherein a gate terminal of each of the plurality of transistors is connected to a PWM signal control unit output; and wherein a source terminal of each of the plurality of transistors is connected to a ground.

12. The backlight of claim 1, wherein the duty ratio of each of the plurality of PWM output signals is between about 1% to about 99%.

13. The backlight as of claim 1, wherein the frequency of each of the plurality of PWM output signals is at least about 160 Hz.

14. A liquid crystal display (LCD), comprising:
a backlight including a plurality of light emitting diodes (LEDs), and
an LED driving circuit configured to drive the plurality of LEDs,
wherein the LED driving circuit includes
an LED driving voltage generation unit configured to generate a driving voltage for driving the plurality of LEDs,
a pulse width modulation (PWM) signal control unit configured to generate a plurality of PWM output signals having a predetermined duty ratio and shifted at a predetermined time interval, wherein the plurality of PWM output signals are generated to drive the plurality of LEDs sequentially, and
a switching unit for performing control such that the driving voltage can be applied to each of the LEDs in response to the plurality of PWM signals;
and
an LCD panel including
a thin film transistor (TFT) substrate,
a color filter substrate facing the TFT substrate, and
an liquid crystal layer injected between the TFT substrate and color filter substrate.

15. The liquid crystal display of claim 14, wherein the TFT substrate is formed using four masks.

16. The liquid crystal display of claim 14, wherein the TFT substrate comprises:
gate lines formed to extend in one direction on a substrate;
data lines formed to intersect the gate lines while being insulated from the gate lines;
TFTs formed at intersection regions of the gate and data lines and connected to the gate and data lines, wherein each of the TFTs includes a gate electrode, a source electrode, and a drain electrode; and
pixel electrodes connected to the TFTs,
wherein each of the data lines including an active layer, an ohmic contact layer, and a layer including the source electrode and the drain electrode, is consecutively deposited and simultaneously patterned.

17. The liquid crystal display of claim 16, wherein the PWM signal control unit has a shift circuit unit configured to shift a PWM input signal having a predetermined duty ratio and at a predetermined time interval, and configured to output a plurality of PWM output signals on respective PWM signal control unit output.

18. The liquid crystal display of claim 17, wherein the plurality of LEDs comprise at least two LED groups, and wherein the at least two LED groups are sequentially driven on an LED group basis.

19. The liquid crystal display of claim 18, wherein each of the at least two LED groups includes at least one LED.

20. The liquid crystal display of claim 16, wherein the duty ratio of each of the PWM signals is between about 1% to about 99%.

21. The liquid crystal display of claim 16, wherein the frequency of each of the PWM signals is at least about 160 Hz.

22. A method for driving a backlight having a plurality of LEDs, comprising the steps of:
generating a driving voltage for driving the plurality of LEDs;
generating a plurality of pulse width modulation (PWM) output signals having a predetermined duty ratio, and shifted at a predetermined time interval; and
applying the driving voltage to each of the LEDs in response to the plurality of PWM signals, wherein the plurality of pulse width modulation (PWM) output signals drive the plurality of LEDs sequentially.

23. The method as claimed in claim 22, wherein the duty ratio of each of the PWM signals is between about 1% to about 99%.

24. The method as claimed in claim 22, wherein the frequency of each of the PWM signals is at least about 160 Hz.
